(19) United States
(12) Patent Application Publication
(10) Pub. No.: US 2018/0275044 A1
(43) Pub. Date: Sep. 27, 2018

(54) SYSTEM AND METHOD FOR LOAD-BASED STRUCTURAL HEALTH MONITORING OF A DYNAMICAL SYSTEM

(71) Applicant: Sikorsky Aircraft Corporation, Stratford, CT (US)

(72) Inventors: Amit Surana, West Hartford, CT (US); Andrzej Banaszuk, Simsbury, CT (US); Raymond Joseph Beale, Jr., Stratford, CT (US); Mark W. Davis, Southbury, CT (US)

(73) Assignee: Sikorsky Aircraft Corporation, Stratford, CT (US)

(21) Appl. No.: 15/762,029

(22) PCT Filed: Sep. 20, 2016
(86) PCT No.: PCT/US16/52587

§ 371 Date: Mar. 21, 2018

Related U.S. Application Data
(60) Provisional application No. 62/233,012, filed on Sep. 25, 2015.

(51) Int. Cl. G01N 19/00; G01N 19/08; G06N 99/00

(52) U.S. Cl. CPC G01N 19/00; G06N 99/005; G01N 19/08

(57) ABSTRACT

A system and method are provided to perform loads-based structural health monitoring (LBSHM) of a dynamical system. The method includes receiving, by at least one computer, sensing data responsive to sensing at least one of a parametrical state and a response of the dynamical system, and determining a Koopman mode and a Koopman eigenvalue. The Koopman mode represents a correlation between the sensor data output by the plurality of sensors. The Koopman eigenvalue represents a frequency component associated with the sensor data and growth or decay of energy associated with the sensor data. The method further includes generating, by the at least one computer, an estimation model to determine a linear estimation based on the Koopman mode and the Koopman eigenvalue that estimates a load response of the dynamical system based on growth or decay of energy associated with the sensor data.

### CROSS REFERENCE TO RELATED APPLICATIONS

The subject invention claims the benefit of and priority to U.S. Provisional Application Ser. No. 62/233,012 filed Sep. 25, 2015, the disclosure of which is herein incorporated by reference in its entirety.

### BACKGROUND OF THE INVENTION

### 1. Field of the Invention

The present disclosure relates to structural health monitoring (SHM) applications and more particularly to improved methods for loads monitoring for load-based SHM applications related to dynamical systems such as rotorcraft.

### 2. Description of Related Art

Conventional load-based SHM methods and systems exist for loads estimating missing load sensor data, and fault detection and isolation in dynamical systems such as rotorcraft. Conventional methods and systems for loads monitoring include the use of physical load sensors and more recently virtual monitoring of loads (VML) that estimate or predict loads using correlations to measurements from other physical sensors. Hybrid VML methods and systems can include certain physical load sensors within the VML method and system. VML and hybrid VML monitor system loads and responses. The term load is used herein in a broad sense and includes, for example and without limitation, mechanical loads, structural loads, electromechanical loads, and electromagnetic loads, without limitation thereto. Responses to loads can be affected by operating conditions. Monitoring of “loads,” as described throughout the disclosure also refers to monitoring of responses. Responses to a load can include, for example and without limitation, mechanical responses, structural responses, electromechanical responses, electromagnetic responses, optical responses, motion, and/or changes in temperature. Operating conditions can include, for example and without limitation, altitude and ambient temperature. Load and response signals may indicate, for example and without limitation, force, moment, torque, stress, strain, displacement, vibration, pressure, temperature, current, and/or voltage. Conventional VML approaches capture quasi-steady correlations in sensor data and/or use non-linear regression modeling. However, it is difficult to adequately capture nonlinearities and transient behavior in sensor data acquired from dynamical system, such as a rotorcraft operating under moderate to severe transient operating conditions when using conventional VML approaches. Similarly, under similar circumstances, it is difficult to estimate missing or corrupted physical sensor data or to predict future sensor data that is based on current or historical physical or virtual sensor data. In addition, detection of a fault and isolation of a detected fault that is determined based on the estimated and/or predicted sensor data can be affected by difficulties associated with estimating or predicting sensor data. Such conventional loads monitoring methods and systems have generally been considered satisfactory for their intended purpose. However, there is still a need in the art for improved loads monitoring, including methods and systems that include both physical, virtual, or both types of sensors (referenced herein as hybrid VML or hybrid models) for dynamical systems such as rotorcraft that routinely experience loads from non-steady-state operating conditions.

Recent advances in data processing methods, such as Koopman Mode Analysis (KMA) (e.g., using Dynamic Mode Decomposition (DMD)), have been used previously to capture nonlinearities and transient behavior in sensor data associated with dynamical systems, such as fluid dynamic systems, video analytics, buildings and power grids. KMA provides a means of extracting modes that describe characteristic behavior patterns of physical systems (e.g., fluid systems or mechanical vibrations). For example, a recirculating flow can be conceived of as a hierarchy of vortices in which a big main vortex drives smaller secondary ones, and so on. Most of the motion of such a system can be faithfully described using only a few of those patterns. KMA provides a means of extracting the modes associated with those patterns from numerical and experimental pairs of time-shifted snapshots. The modes identified by KMA are associated with a respective fixed oscillation frequency and growth/decay rate. KMA can determine growth rates of spatial modes and local frequencies using a linear operator that can be associated with a nonlinear dynamical system. This is to be contrasted with methods, such as the proper orthogonal decomposition (POD), which produces a set of modes without the associated temporal information.

However, the captured information only describes nonlinearities and transient behavior of the dynamical system that was actually sensed. The methods using Koopman Mode have not previously been used for advanced loads monitoring or loads-based SHM as described herein. Additionally, VML-based SHM fault detection and isolation methods are emerging, but would be improved through the application of loads monitoring techniques that better capture nonlinearities and transient dynamical system behavior.

### SUMMARY OF THE INVENTION

In accordance with an aspect of the disclosure, a system and method is provided to perform loads-based structural health monitoring (LBSHM) of a dynamical system. The system includes a computer configured to receive sensor data output by a plurality of sensors sensing at least one of a dynamical parametrical state and a response of the dynamical system. The computer is further configured to determine at least one Koopman mode and at least one Koopman eigenvalue. The Koopman mode represents a correlation between the sensor data output by the plurality of sensor, and the Koopman eigenvalue represents a frequency component associated with the sensor data and growth or decay of energy associated with the sensor data. The computer is further configured to generate an estimation model to determine a linear estimation based on the at least one Koopman mode and the at least one Koopman eigenvalue that estimates a load response of the dynamical system based on growth or decay of energy associated with the sensor data.

In embodiments, the computer is further configured to receive sensor data output by a plurality of sensors sensing a load of the dynamical system.

In embodiments, the dynamical system can be a rotorcraft. Furthermore, in embodiments, a dynamic mode decomposition method can be used to determine the Koopman mode and eigenvalue.

In embodiments, the estimation model can be used to estimate sensor data associated with a location remote from the plurality of sensors. The estimation model can also be used to predict sensor data associated with a future time. The estimation model can further be used to estimate sensor data that correspond to virtual sensor locations only. Furthermore, the estimation model can be used to estimate sensor data that correspond to a combination of physical sensor and virtual sensor locations. Additionally, the estimation model can be used to determine accuracy of the estimation model. In embodiments, the estimation model can be used to detect that sensor data that is expected is not available (i.e., unavailable), missing, or corrupt. The estimation model can be used to determine reconstructed sensor data for sensor data that is not available, missing or corrupt. The estimation model can be used to at least one of detect and isolate a fault in the dynamical system. The estimation model can further be used to determine an optimal physical sensor network for use by the dynamical system.

In accordance with an aspect of the disclosure, a method is provided to capture spatiotemporal correlations in data sensed from a dynamical system. The method includes correlating, by at least one computer, spatial and temporal characteristics of sensor data from a plurality of sensors sensing load and load response of a dynamical system using a Koopman mode. The method further includes representing, by the at least one computer, a frequency component associated with the sensor data and growth or decay of energy associated with the sensor data using a Koopman eigenvalue. In addition, the method includes generating, by the at least one computer, a linear estimation based on the Koopman mode and the Koopman eigenvalue to estimate a load response of the dynamical system based on growth or decay of energy associated with the sensor data.

These and other features of the systems and methods of the subject disclosure will become more readily apparent to those skilled in the art from the following detailed description of the preferred embodiments described in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail below with reference to certain figures, wherein:

FIG. 1 shows a schematic diagram of an exemplary Load-Based Structural Health Monitoring (LBSHM) system used in conjunction with a rotorcraft dynamical system;

FIG. 2 is a flow diagram of an exemplary LBSHM system with examples of exemplary modules;

FIG. 3 is a flowchart of a method for performing sensor network optimization in accordance with an aspect of the disclosure;

FIG. 4 is a flow diagram of a portion of the LBSHM system in accordance with another embodiment of the disclosure, with a Proper Orthogonal Decomposition (POD) module for transforming load data into POD coefficient space; and

FIG. 5 is a flow diagram of a portion of the LBSHM system in accordance with another embodiment of the disclosure, with a Kalman filter to estimate POD coefficients and a POD reconstruction module to perform POD reconstruction.

### DETAILED DESCRIPTION OF THE PREFERRED EMBODIMENTS

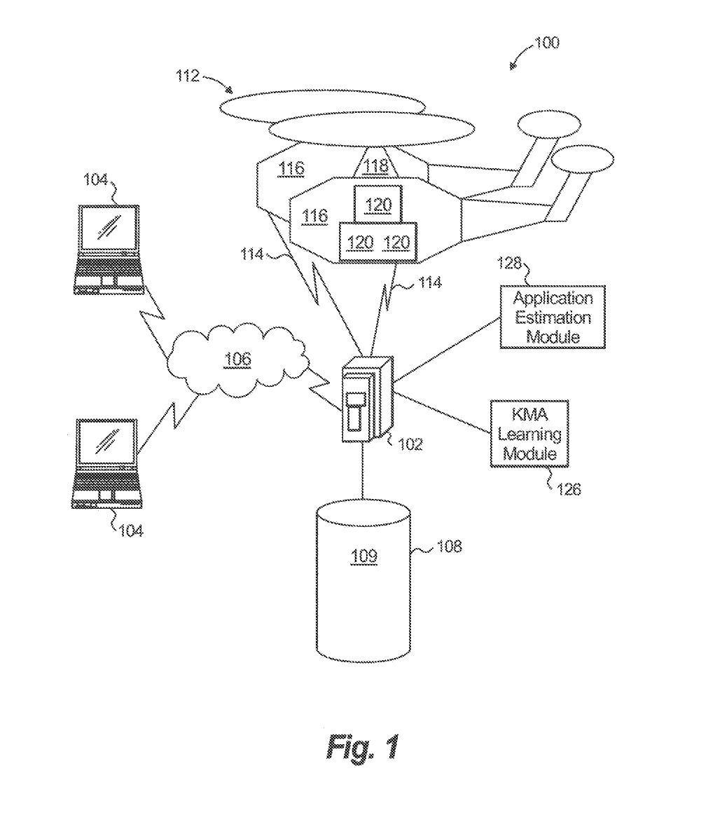

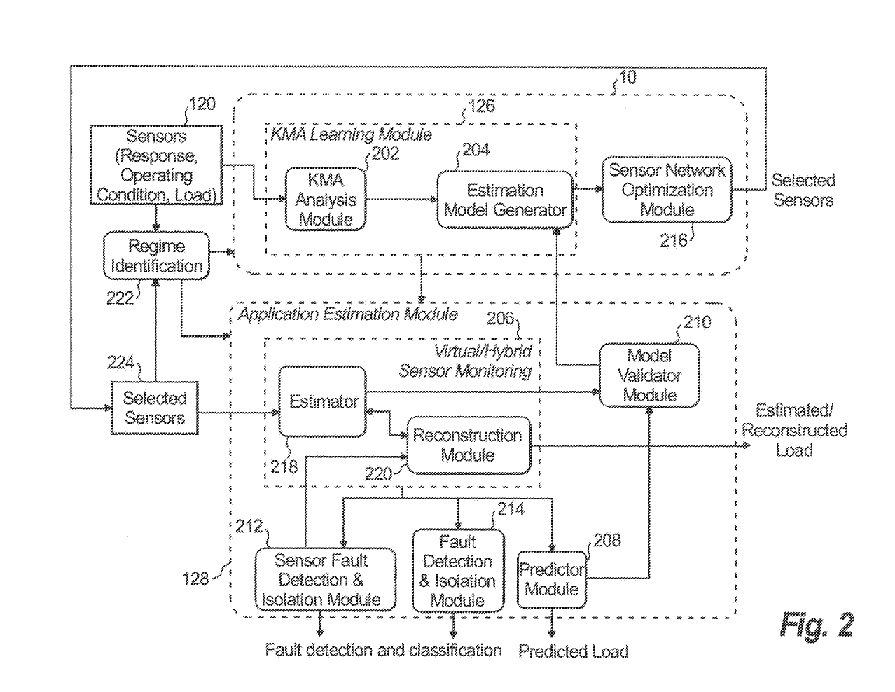

Reference will now be made to the drawings wherein like reference numerals identify similar structural features or aspects of the subject disclosure. For purposes of explanation and illustration, and not limitation, a flow diagram of an exemplary embodiment of a Load-Based Structural Health Monitoring (LBSHM) system in accordance with the disclosure is shown in FIG. 1 and is designated generally by reference character 100. Other embodiments of the LBSHM system in accordance with the disclosure, or aspects thereof, are provided in FIGS. 2-5, as will be described. The systems and methods described herein can be used to provide improved estimation, prediction, and monitoring of loads and responses in a dynamical system, for example in aerospace applications such as rotorcraft. The present disclosure also provides for application of a Koopman Mode Analysis (KMA) technique, such as Dynamic Mode Decomposition, to rotorcraft sensor data for a LBSHM monitoring system. Other applications of the systems and methods described herein include without limitation usage and loads-based maintenance, condition-based maintenance, and system health management.

Embodiments of the present invention focus on capturing nonlinearities and transient behavior in sensor data associated with a dynamical system, providing a linear estimation model that can model nonhinearities and transient behavior associated with the dynamical system, and modeling a virtual sensor. Using a combination of KMA and estimation theory, captured information using KMA not only describes nonlinearities and transient behavior of the dynamical system that was actually sensed, but can also be used to estimate an aspect of a dynamical system which was not actually sensed, enabling enhanced Virtual Monitoring of Loads (VML), which can include VML (using data from only virtual sensors) or hybrid VML (using data from both virtual sensors and physical sensors). VML and hybrid VML monitor system loads and responses to loads (also referred to herein as “loads”) that may be affected by operating conditions, such as, but not limited to, altitude and ambient temperature. The LBSHM system 100 can be applied to model spatiotemporal behavior including nonlinearities and transients in a dynamical system that includes dynamical system loads and responses, which evolve as a function of time and operating condition. A dynamical system is a physical entity, such as a vehicle, machine, conduit, cable, vessel, or object, without limitation thereto, whose state evolves with time over a state space according to a fixed rule. Examples of dynamical systems include, for example, rotorcraft, engines, ground-based power systems, and HVAC systems (heating, ventilation and cooling systems). In an example, the embodiments disclosed herein may be applied to a LBSHM system, method, and/or computer program product that optimally measure and/or estimate load information from a fleet of dynamical systems such as a fleet of vehicles (e.g., rotorcraft). Loads include the static or dynamic characteristics (e.g., stress, strain, displacement, acceleration) encountered by a vehicle and/or components thereof. As used in this specification, the term “load” can include, for example and without limitation, mechanical loads, electromechanical loads, electromagnetic loads, etc. The responses can include, for example and without limitation, structural responses, electromechanical responses, electromagnetic responses, optical responses, etc. to a load; therefore, load signals and responses may indicate, for example, force, moment, torque, stress, strain, current, and/or voltage. Note that the nominal (e.g., healthy) static and dynamic characteristics of loads are also strongly influenced by operating conditions associated with the vehicle.

FIG. 1 is an example of a LBSHM system 100 for monitoring dynamical system loads and associated responses, herein discussed with respect to an aircraft (e.g., rotorcraft). The LBSHM system 100 includes a computing sub-system 102 in communication with remote computing sub-systems 104 over a network 106. The computing sub-system 102 can access a database 108 to read and write data 109 either autonomously or in response to requests from the remote computing sub-systems 104. An end user of the LBSHM system may interrogate the database 108 to support system maintenance or health management decisions, according to advanced maintenance paradigms, such as usage or loads based maintenance or condition-based maintenance.

The computing sub-system 102 and/or the remote sub-systems 104 are also configured to communicate with an aircraft fleet 112 via communication links 114. The aircraft fleet 112 can include a variety of aircraft 116, such as fixed-wing and rotorcraft. The communication links 114 can be wireless communication links. The communication links 114 may also support wired and/or optical communication when the aircraft 116 are on the ground and within physical proximity to the computing sub-system 102. Alternatively, the transfer of data between the computing processors on the aircraft and computing sub-system 102 and remote computing sub-system 104 may be done manually using portable digital media such as a digital smart card, memory stick, etc. In exemplary embodiments, the computing sub-system 102 and other components of the LBSHM system 100 may be integral to the aircraft 116, such that the LBSHM system 100 reliably and automatically measures loads associated with the aircraft 116 and outputs sensor data, estimates and/or predicts loads, and determines growth or decay of energy associated with the sensor data. Further, in exemplary embodiments, the aircraft fleet 112 transmits flight data to at least one of the computing sub-system 102 or remote sub-systems 104 for load spectrum assessment and refinement, structural fault detection, etc.

In the example depicted in FIG. 1, each aircraft 116 is a rotorcraft with a main rotor 118 capable of revolving at a sufficient velocity to sustain flight. Aircraft 116 also includes a plurality of sensors 120 configured to transmit sensor data. The sensor data can include load data and/or aircraft parametric state data. Examples of aircraft parametric state data include, without limitation, state parameters, operating parameters, and systems responses. State parameters can include uncontrolled parameters (e.g., outside air temperature). Operating parameters can include, for example, aircraft characteristics and pilot control input (e.g., pilot stick position, engine torque, gross weight). System responses can include low frequency or high frequency aircraft responses (e.g., rate of climb, aircraft pitch or roll attitude, forward flight speed, and engine temperature, vibratory loads, and vibratory accelerometer responses).

The sensor data is transmitted to the LBSHM system 100 by the sensors 120 and/or an intermediary sub-system that receives the sensor data from the sensors 120. The sensors 120 can be communicatively coupled to each other and can be incorporated with or external to each other. In exemplary embodiments, the sensors 120 communicate wirelessly with computing sub-system 102 or an intermediary sub-system.

The sensors 120 are converters that measure physical quantities and convert these physical quantities into a signal (e.g., sensor data) that is read by the LBSHM system 100. Meaningful sensor data can be obtained by positioning the sensors 120 at strategic locations. In one example, the sensors 120 include strain gauges that measure the physical responses to stress applied to a component of the aircraft 116 (e.g., a rotor hub, airframe structural element, a landing gear assembly, etc.). In another example, the sensors include temperature sensors that measure the temperature characteristics and/or the physical change in temperature of an aircraft component, fluid (e.g., oil), and/or gas (e.g., engine exhaust).

Furthermore, the sensors 120 are representative of a plurality of sensors monitoring different location and portions of each aircraft 116 with respect to different aircraft state parameters, including state parameters, operating parameters, systems responses, and/or loads. For example, a first sensor 120 may be located in the engine to measure engine temperature, a second sensor 120 may be located external to the airframe to measure outside air temperature, a third sensor 120 may be located elsewhere in the airframe to measure aircraft roll attitude, a fourth sensor may be located on a main rotor shaft to detect a main rotor torque, a fifth sensor 120 may be located on a main rotor hub to detect bending with respect to the main rotor shaft, etc. Irrespective of the precise location, the sensors 120 can also be positioned in different orientations so that different directional forces may be detected.

In addition to the above, the computing sub-system 102 includes a KMA based learning module 126 and an estimation module 128. The KMA learning module 126 includes computer readable program instructions configured to process historical data from the sensors 120 to determine at least one Koopman mode (“Koopman modes”) and at least one Koopman eigenvalue (“Koopman eigenvalues”). The Koopman modes capture correlations between sensor data output by the plurality of sensors 120, including between sensor data output over time and/or sensor data associated with different aspects and/or locations of the dynamical system 100. The Koopman eigenvalues represent a frequency component associated with the sensor data and growth or decay of energy associated with the sensor data.

Further, the KMA learning module 126 generates an estimation model based on the Koopman modes and the Koopman eigenvalues to estimate at least one of dynamical system states (e.g., aircraft parametric states), loads, and responses. The estimation model can be used to model a virtual sensor for estimating or predicting virtual sensor output. In one embodiment, the KMA learning module 126 uses Dynamic Mode Decomposition (DMD), which determines Koopman modes and Koopman eigenvalues used in the estimation application module 128.

The estimation application module 128 includes computer readable program instructions configured to process the output from the KMA learning module 126 to estimate at least one of dynamical system states (e.g., aircraft parametric states), loads, and responses. The estimation can be used to perform at least one of virtual and/or hybrid monitoring of loads, predicting motion or loads, validating the KMA learning module 126, detecting and/or isolating faults in the dynamical system, and optimizing a network of sensors.

The computing sub-system 102 is a computing device (e.g., a mainframe computer, a desktop computer, a laptop computer, or the like) including at least one processing circuit (e.g., a CPU) capable of reading and executing instructions stored on a memory therein, and handling numerous interaction requests from the remote computing sub-systems 104. The computing sub-system 102 may also represent a cluster of computer systems collectively performing estimation and measuring processes as described in greater detail herein. The remote computing sub-systems 104 can also include at least one of a desktop, laptop, general-purpose computer devices, and networked devices with processing circuits and input/output interfaces, such as a keyboard and display device.

The computing sub-system 102 and/or the remote computing sub-systems 104 are configured to provide a process, where a processor may receive computer readable program instructions from a logic to perform operations of the LBSHM logic (as described below) of the memory and execute these instructions, thereby performing one or more processes defined by the usage and loads based maintenance logic. The processor may include any processing hardware, software, or combination of hardware and software utilized by the computing subsystem 102 and/or the remote computing sub-systems 104 that carry out the computer readable program instructions by performing arithmetical, logical, and/or input/output operations. For example, the computer readable program instruction may include software that performs at least one of load estimation, load prediction, load spectrum assessment and refinement for design, testing, and certification of any aircraft system that has fatigue sensitive or life-limited components (e.g., dynamic components of a rotorcraft).

The memory may include a tangible device that retains and stores computer readable program instructions, as provided by the logic to perform operations of the LBSHM, for use by the processor of the computing sub-system 102 and/or the remote computing sub-systems 104. The computing sub-system 102 and/or the remote computing sub-systems 104 can include various computer hardware and software technology, such as one or more processing units or circuits, volatile and non-volatile memory including removable media, power supplies, network interfaces, support circuitry, operating systems, user interfaces, and the like. Remote users can initiate various tasks locally on the remote computing sub-systems 104, such as requesting data from the computing sub-system 102.

The network 106 may be any type of communications network, including a local area network (LAN) or a wide area network (WAN), or the connection may be made to an external computer (for example, through the Internet using an Internet Service Provider). For example, a network may be the Internet, a local area network, a wide area network, satellite network, and/or a wireless network, comprise copper transmission cables, optical transmission fibers, wireless transmission, routers, firewalls, switches, gateway computers and/or edge servers, and utilize a plurality of communication technologies, such as radio technologies, satellite technologies, cellular technologies, etc.

The LBSHM database 108 may include a database, data repository, or other data store and may include various kinds of mechanisms for storing, accessing, and retrieving various kinds of data, including a hierarchical database, a set of files in a file system, an application database in a proprietary format, a relational database management system (RDBMS), etc. The data 109 of the maintenance database 108 can include empirical models, estimated data, estimated features, sensed data, damage metrics, maintenance schedules, maintenance policies, etc. For example, the data 109 can include archived historical fleet data for a rotorcraft, and estimated loads to support assessment and refinement of the load spectrum for design, testing, and certification of rotorcraft components.

While either of the KMA learning module 126 and estimation application module 128 (and other items in FIGS. 2-4) is illustrated as a single item, these representations are not intended to be limiting and thus, the KMA learning module 126 and estimation application module 128 items may each represent a plurality of modules. For example, multiple modules in different locations may be utilized to access the collected information, and in turn those same modules may be used for on-demand data retrieval. In addition, although one configuration of each of the KMA learning module 126 and estimation application module 128 is described, it should be understood that the same operability may be provided using fewer, greater, or differently named modules.

In view of the above, the LBSHM system 100 and elements therein of the FIGS. 1-5 may take many different forms and include multiple and/or alternate components and facilities. That is, while the aircraft 116 is shown in FIG. 1, the components illustrated in FIGS. 1-5 are not intended to be limiting. Indeed, additional or alternative components and/or implementations may be used. For instance, the sensors 120 may include and/or employ any number and combination of sensors, computing devices, and networks utilizing various communication technologies, as described below, that enable the LBSHM system 100 to perform the KMA-based, generation of an estimation model, and estimation of dynamical system states, loads and responses, and any combination thereof, as further described with respect to FIGS. 2-5.

With reference to FIG. 2, a flow diagram shows processing of sensor data and related data by modules of the LBSHM system 100 including the KMA learning module 126 and the estimation application module 128.

An arrow pointing from a group of modules surrounded by a dashed box indicates that each of the modules included in the dashed line can output data that can be received by a destination that is indicated by the arrow. Similarly, an arrow pointing to a group of modules surrounded by a dashed box indicates that each of the modules included in the dashed line can receive data that provided from a source that is indicated by the arrow. For example, the arrow pointing from box 10 to application estimation module 128 indicates that modules 202, 204 and 216 can output data that can be received by any of modules 208, 210, 212, 214, 218, and 220.

Sensor data is received directly or indirectly by the KMA learning module 126 from the plurality of sensors 120. The KMA learning module 126 includes a KMA module 202 and an estimation model generator module (“estimation model generator”) 204. One embodiment of the KMA module 202 is based on Dynamic Mode Decomposition (DMD). The output from the estimation model generator 204 can be processed by one or more modules of estimation application module 128, including a virtual/hybrid monitoring module 206, a predictor module 208, a model validator module 210, a sensor fault detection and isolation module 212, a fault detection and isolation module 214, and a sensor network optimization module 216. The KMA learning module 126, virtual/hybrid monitoring module 206, predictor module 208, model validator module 210, sensor fault detection and isolation module 212, fault detection and isolation module 214, and the sensor network optimization module 216 can each be executed in batch or streaming mode. In batch mode sensor data has been historically collected and all the data is available for processing at once. In streaming mode sensor data comes in real time, e.g., onboard an aircraft during flight.

The KMA module 202 can perform KMA using a multiple pass operation. Similarly, the estimation model generator 204 can perform estimation model generation with a multiple pass operation.

The KMA module 202 is described in detail below using an exemplary embodiment that uses DMD to analyze sensor data {y₀, . . . y_{T}} using a Koopman operator to expand the sensor data as indicated by Equation (1):

$${y}_{t} = {\sum }_{j = 1}^{T} {λ}_{j}^{t} {c}_{j} {v}_{j} , t = 0 , ⋯ , T \qquad ( 1 )$$

where;

subscript t denotes discrete time steps,

vⱼ are Koopman Modes (KM),

λⱼ are Koopman eigenvalues (KE), and

cⱼ=φ(x₀) are scalar constants which depend on Koopman eigenfunctions φⱼ(x₀), where x₀ is hidden state.

While KMA can be thought of as a generalized Fourier analysis, KMA is able to determine modal growth/decay rates, whereas a Discrete Fourier Transform (DFT) does not. As used hereinafter, the term “KMA” refers collectively to Koopman eigenvalues and corresponding Koopman modes obtained from sensor data.

KMA eigenvalues capture a dynamical aspect of a dynamical system by capturing modal growth/decay rates and oscillatory behavior, if present, in the sensor data. Each KMA mode represents a single frequency component. Thus, KMA can decouple dynamics at different time scales.

Dynamical sensor data such as that from a rotorcraft is intertwined with elaborate and overlapping nonlinear spatiotemporal behavior. KMA can robustly isolate different frequencies and their decay/growth rates from the sensor data. By capturing decay/growth rates, KMA can capture transient behavior. Once the frequencies of interest have been isolated, the corresponding Koopman triodes can be used to gather additional information and correlations in the data.

For example, the estimation model that is output by the estimation model generator 204 can be used by the virtual/hybrid monitoring module 206 to estimate and monitor loads, which can be used within the LBSHM system 100 to estimate useful/retirement life of a component of the dynamical system and facilitate usage/loads-based maintenance (ULBM) or condition based maintenance (CBM) approaches for reducing maintenance cost and/or time. The estimations and monitoring can further be used to detect missing and/or corrupted sensor data (e.g., due to lossy wireless transmission), and to reconstruct the missing sensor data and/or correct the corrupted sensor data. The estimations and monitoring also can be used in conjunction with data compression for fleet load monitoring and maintenance scheduling.

The estimation model output by the estimation model generator 204 can be used by the predictor module 208 to monitor and/or predict/forecast loads and to obtain estimates of loads from historical data, e.g., for design purposes. The estimations and predictions can be monitored by the model validator module 210, which can include comparing predicted sensor data with actual sensor data to determine accuracy of the estimation model and to adjust the estimation model.

The estimation model output by the estimation model generator 204 can be used by the sensor fault detection and isolation module 212 to detect a faulty sensor and isolate the faulty sensor, such as to quarantine resulting sensor data.

The estimation model output by the estimation model generator 204 can be used by the fault detection and isolation module 214 to perform early detection and diagnoses of fault conditions, which can facilitate reduction of aircraft maintenance costs and enhance flight safety. For example, helicopter rotor systems may be subject to a number of fault types such as imbalance, track splits, cracks, defects, and free play or friction in the pitch control systems, lag systems and flap systems.

The estimation model output by the estimation model generator 204 can be used by the sensor network optimization module 216 to improve or optimize sensor data capture and reduce or minimize sensor installation and maintenance cost.

In an embodiment, the KMA module 202 performs DMD. One embodiment uses DMD to perform a full nonlinear analysis of data without making any linearity assumption. KMA further provides a modal decomposition that captures oscillatory behavior in the sensor data with growth/decay rates and can thus capture transients in the data. The KMA includes generating Koopman modes and Koopman eigenvectors. The Koopman modes represent a relationship between the sensor data (and therefore the sensor or the characteristic being sensed) and physical space. The Koopman eigenvalues represent a frequency component associated with the sensor data and growth or decay of energy (e.g., an increase or decrease in magnitude) associated with the sensor data. Growth or decay of energy associated with the sensor data can be indicated by changes in amplitude of sensor signals included in the sensor data.

Other embodiments of the KMA module 202 can apply, for example, an Arnoldi type method, exact DMD, extended DMD (EDMD), sparse DMD or a method that uses harmonic averages of the sensor data to perform the KMA. In principle any numerical method that computes Koopman eigenvalues and Koopman modes can be used. KMA can be carried out both on or off of attractors using these methods and their variants. The Koopman modes can be scaled in different ways. An algorithm for performing KMA can be based on a single time series or multiple time series

Algorithm (1) below provides an example for carrying exact DMD

Algorithm (1):
1: Arrange sensor data Y_{0:T}={y₀, - - - , y_{T}} into matrices

X=[y₀, - - - , y_{T-1}] Y=[y₁, - - - , y_{T}].
2: Compute singular value decomposition (SVD) of X, writing X=UΣV*, where * denotes matrix transpose
3: Define matrix A=U·Y V Σ⁻¹, where superscript −1 denotes matrix inverse
Compute the eigenvalues and eigenvectors of A, writing Awᵢ=λᵢwᵢ. Each nonzero eigenvalue λᵢ is a Koopman eigenvalue. 5: The Koopman mode vᵢ corresponding to Koopman eigenvalue λᵢ is then given by

vᵢ=Y V Σ⁻¹wᵢ/λᵢ

The estimation model generator 204 uses the Koopman modes and Koopman eigenvalues to generate an estimation model. A linear estimation is used in which an initial condition can be unknown and complex conjugate pairs of Koopman eigenvalues and scaled eigenmodes are replaced by real and imaginary parts, respectively. Approximations can be modeled with the example estimation model:

zₜ₊₁=Λ^{r}zₜ+sᵢ (3)

yₜ=C^{r}zₜ+mₜ (4)

where,
subscript t denotes discrete time step and superscript r denotes the real form,
zₜ is the N dimensional state vector of modal coefficients, with z₀˜N(z₀,P₀) being the unknown initial modal coefficient assumed to be normally distributed with mean z₀ and covariance P₀,
yₜ is the sensor data which is an m-dimensional vector,
Λ^{r} is a real block diagonal matrix formed from Koopman eigenvalues (where there is a diagonal entry for each real λᵢ and a 2×2 block diagonal entry for each pair of complex λᵢ), whose size is N×N, where N are the number of retained Koopman modes,
C^{r} is real observation matrix whose columns are formed from the Koopman modes vᵢ (where there is single column for each real vᵢ, while for complex vᵢ two columns are added corresponding to real and imaginary parts of vᵢ) which is of size m×N, and
sₜ˜N(0, Q) is zero mean modeling noise with covariance Q, mₜ˜N(0, R) is zero mean sensor noise with covariance R.

Accuracy of the estimation model provided in Equations (3) and (4) can depend upon quality of a training data set used for sensor data Y_{0:T}. Training data can be selected to cover a broad range of dynamical system operating conditions (e.g., aircraft flight conditions, such as level flight, takeoff, turns, pull-outs, push-overs, and dives, pilot inputs, and other disturbances). Provision of a broad coverage of training data can generate an estimation model that is robust for a broad range of equipment configurations and operating conditions.

In order to build local models for each regime of operation, a method for partitioning the data can be used. Such a method can automatically determine a regime and partition the training dataset during training phase. A separate local estimation model can be learned for each regime. For sensor estimation, a regime identification module 222 can be used to identity an appropriate regime of operation so that an appropriate local estimation model can be selected for sensor estimation purposes. Note that any regime identification method can be used in conjunction with LBSHM. Arrows pointing from the regime identification module 222 to the KMA learning module 126 and the application estimation module 128 indicate that output from the regime identification module 222 can be used by any of the modules in the KMA learning module 126 and the application estimation module 128.

The estimation model output by the KMA learning module 126 can be used by the virtua/hybrid monitoring module 206 to model a virtual sensor and to perform virtual and/or hybrid monitoring of loads at a current or past time. A transfer function can be constructed based on the estimation model. The transfer function can provide a statistically accurate estimate of a desired system measurement (e.g., a structural load) using dynamical system states (e.g. aircraft parametric states), loads, and responses, such as airspeed, torque, altitude, collective position, cyclic longitudinal position, cyclic lateral position, and vertical acceleration for a rotorcraft LBSHM system, as inputs. Such parameters may be readily available on rotorcraft, for example, that are equipped with a health usage and monitoring system (HUMS) or an integrated vehicle health management system (IVHMS).

The virtual/hybrid monitoring module 206 can include an estimator 218 that uses the estimation model output by the estimation model generator 204 to estimate virtual sensor output at selected locations that can be remote from the locations of actual physical sensors that provided actual physical sensor data that was processed by the KMA module 202.

A scenario is considered in which only a subset of sensor data y^{o}ₜ is measured compared to all of the sensors yₜ used in training. To estimate remaining unmeasured sensor values y^{u}ₜ, the estimator 218 uses an estimator, e.g., a Kalman filter, in conjunction with the estimation model in accordance with Equations (5) and (6),

zₜ₊₁=Λ^{r}zₜ+sᵢ, (5)

y^{o}ₜ=C^{ro}zₜ30 mₜ, (6)

where, C^{ro} is a part of C^{r} matrix whose rows correspond to only the measured sensor data.

Given the measured sensor data y^{o}ₜ, t=1, 2, . . . the Kalman filter can recursively compute estimate of the z^{c}ₜ, t=1, 2, . . . , which can be used to estimate unmeasured sensor data y^{a}ₜ as follows:

y^{u}ₜ=C^{ru}zₜ^{c}, t=1, 2 (7)

where, C^{ra} is part of C^{r} matrix whose rows correspond to unmeasured sensor data.

The Kalman filter combines the estimation model of Equation (5) and the sensor data in an optimal fashion (e.g., minimum mean square error) to compute a state estimate and its covariance. In this fashion, a transfer function can be constructed for estimating and predicting unmeasured sensor data. In addition, the estimated and predicted sensor data can be used to estimate loads at locations that are remote from actual sensors and to predict loads at future times.

The virtual/hybrid monitoring module 206 can further include a reconstruction module 220 that reconstructs missing data, such as when sensor data from a particular sensor is not available, e.g., due to a communication failure. That sensor can be removed from a list of observed sensors, and sensor data for that sensor can be estimated like the other unmeasured sensor values in accordance with Equation (7). An estimated reconstructed load can be estimated and output. Sensor fault detection and isolation module 212 can indicate faulty sensors that were identified. When a probability of communication packet sensor data drop is known, the reconstruction module 220 can account for the dropped sensor data by adjusting the estimator 218. When the sensor fault detection and isolation module 212 identifies the faulty sensor, the reconstruction module can compensate for the missing sensor data by substituting reconstructed sensor data.

Information output by the virtual/hybrid monitoring module 206 is provided to the predictor module 208, the sensor fault detection and isolation module 212, and/or the fault detection and isolation module 214.

The predictor module 208 can monitor and/or predict future loads, which can be useful for load-limiting or life-extending control to extend the life of components of the rotorcraft for instance. The prediction of sensor values can be carried out as follows. Let the state estimate at a current time t using the estimator 218 be zₜ^{e}. Then by iterating Equations (8) and (9) of estimation model's equations (3) and (4) without the noise terms sₜ and mₜ,

zₜ₊₁=Λ^{r}zₜ, (8)

yₜ=C^{r}zₜ (9)

over t+1, t+2, - - - , t+T with zₜ=zₜ^{e}, the predictor module 208 can compute predicted future nominal values yₜ of both the measured and unmeasured sensors over the chosen time horizon T. The predictor module 208 can also apply an online prediction approach which does not require a priori knowledge of the estimation model (Λ^{r}, C^{r}). For example, the predictor module 208 can compute in accordance with Equation (10):

$${y}_{t} \approx {\sum }_{j = 1}^{N} {λ}_{j}^{t} \overline{{v}_{j}} t = T + 1 , T + 2 , ⋯ . \qquad ( 10 )$$

Output from the predictor module 208 can be used by the sensor fault detection and isolation module 212 and/or the fault detection and isolation module 214 to detect and isolate faults and faulty sensors that may occur in the future.

The model validator module 210 can monitor accuracy of the estimation model, which can be influenced by various factors, such as variability in manufacturing processes, data falling outside the domain of training data, and changes over time due to age of the dynamical system, and variability in system usage beyond that used to train the estimation models. In one embodiment, a criterion for validity of the model is defined based on an error metric between the estimated sensor values and the actual sensor data. The error metric can be compared to a threshold value. This criterion can be used to adjust the estimation model or to terminate using the estimation model, e.g., by resorting to worst case design assumptions. For example the estimation model can be adjusted by using the actual sensor data collected and using the KMA learning module to update the Koopman modes/eigenvalues and subsequently update the estimation model via Equations (3) and (4).

Dynamical systems, such as rotorcraft systems, may be subject to a number of fault types. Early detection and diagnoses of fault conditions facilitates the reduction of aircraft maintenance costs and further enhances flight safety.

The sensor fault detection and isolation module 212 can use a Kalman filter based estimation and/or outputs from estimator 218. For example, a bank of Kalman filters can be used, where each filter is designed with a unique fault hypothesis to monitor a specific sensor. When a single sensor fails, only the filter with the correct fault hypothesis would maintain low residual values, indicating that the associated specific sensor has failed. Sensor fault detection can be applied to a single sensor failing at a time or to multiple sensor failures at a time.

The fault detection and isolation module 214 may perform a method of real-time fault detection that is designed based on the estimated and/or predicted sensor data. The estimated sensor data and/or predicted sensor data is compared to the measured sensor data to detect differences that can indicate a fault and isolate a cause of the fault.

A load monitoring system and method can include a hybrid of virtual sensing by virtual sensors and actual sensing by real (e.g., actual or physical) load sensors. The sensor network optimization module 216 can determine what type of actual physical sensors are needed so that a hybrid selection of virtual and real sensors increases or optimizes estimation performance and/or decreases or minimizes LBSHM system cost. The sensor network optimization module 216 can determine which physical sensors should be deployed for obtaining a combination of actual physical sensor data and estimated sensor data, where the actual sensor data is obtained from the physical sensors and the estimated sensor data is obtained using the estimation model.

Given a set of sensors and budget constraints, one formulation of sensor network optimization is to select a subset of physical sensors that will generate actual sensor data, where the remaining sensor data can be estimated as accurately as possible, e.g., by virtual sensors, while satisfying the budget constraint. Different criterions can be used for budget and estimation accuracy. For example, budget can be determined based on a total number of sensors used or a total capital and/or installation cost, while estimation accuracy can be quantified using control theoretic observability notions, information theoretic measures etc., which are defined based on the estimation model generated from the estimation model generator 204. In addition, other criteria can be considered related to robustness to sensor failures and detectability of faults. The sensor selection problem can be solved using a heuristic solution that addresses a combinatorial optimization problem.

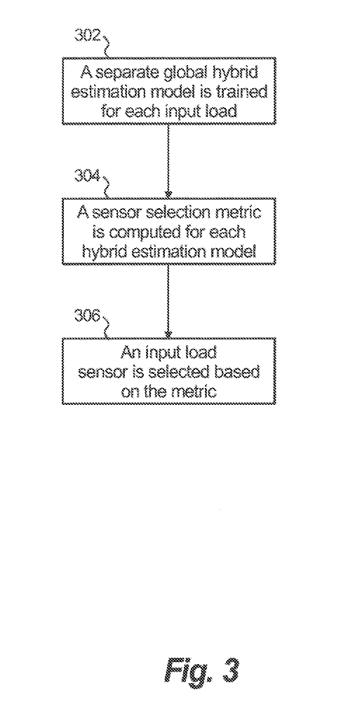

The sensor selection can be performed using modeled sensor data that was obtained using the estimation model. With reference now to FIG. 3, shown is a flowchart demonstrating implementation of the various exemplary embodiments. It is noted that the order of steps shown in FIG. 3 is not required, so in principle, the various steps may be performed out of the illustrated order. Also certain steps may be skipped, different steps may be added or substituted, or selected steps or groups of steps may be performed in a separate application following the embodiments described herein. It will be understood that each block of the flowchart, and combinations of blocks in the flowchart, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart blocks.

FIG. 3 shows a flowchart that illustrates an example method of sensor optimization for hybrid or virtual estimation of a given load that is performed by the sensor network optimization module 216. At operation 302, a separate global hybrid estimation model is trained using training data for each input load based on the KMA module 202 and the estimation generator module 204. As discussed above training sensor data is input to KMA module 202 which computes the Koopman modes and eigenvalues. At operation 304, a sensor selection metric is computed for each hybrid estimation model. At operation 306, an input actual load sensor is selected based on the metric.

In operation 304, the sensor network optimization module 216 selects a sensor selection metric. In an embodiment, the metrics are broadly categorized, such as based on observability Gramian, using a deterministic concept. This operation can include maximizing measure of distance away (e.g., using a minimum singular value of Gramian) from unobservability, and/or maximizing observability (e.g., using a sum of singular values).

In a further embodiment, a sensor selection metric is selected based on a filter estimation error, which incorporates model error and/or sensor noise. This operation includes using a minimize function (e.g., trace) of steady state filter error covariance, and/or an information theoretic measure.

In a further embodiment, a sensor selection metric is selected using computation of a virtual monitoring of loads (VML) accuracy metric (e.g., waveform correlation and/or RMS relative to the validation dataset).

The sensor network optimization module 216 can use various metrics for sensor selection. For example, singular values of observability Gramian associated with system of equations (3) and (4) can quantify how much output energy is excited with an initial condition being the corresponding singular vector. Moreover, an unobservable subspace can be spanned by components of singular vectors that correspond to zero singular values. A trace of Gramian can measure average output energy excited over initial conditions on a unit sphere.

Several metrics for sensor placement based on observability Gramian can be defined, and can be broadly divided into categories, such as measures based upon the least observable direction in the state space, and measures influenced by the largest singular value of the observability Gramian.

In an embodiment, sensor placement metrics can be defined based on Kalman filter estimation error, which incorporates model error and/or sensor noise based on system of equations (3) and (4). For example, trace of a steady state error covariance for Kalman filter can be considered as a sensor selection metric for estimating unmeasured sensor data. Information theoretic measures, such as mutual information and entropy, for the filter can also be defined and used as a metric for sensor selection. In operation 306, the sensor network optimization module 216 solves a sensor selection optimization problem. In an embodiment, the sensor network optimization module 216 can use a heuristic based on submodular function maximization with an objective based on an observability Gramian. The heuristic can further be based on a budget constraint associated with a total number of sensors or related costs.

Sensor selection problems tend to be combinatorial optimization problems which can become intractable for even small number of sensors. Accordingly, appropriate heuristics can be used to solve such problems to obtain polynomial time approximate solutions. For example, a heuristic procedure can be used with the selected metric based on an observability Gramian.

In some instances, a sensor selection objective function can be modular in which the optimization problem can be obtained by greedy solution. In an embodiment, the solution can further be based on a cost constraint. A variation of a greedy solution approach can be used to obtain near optimal polynomial time solutions.

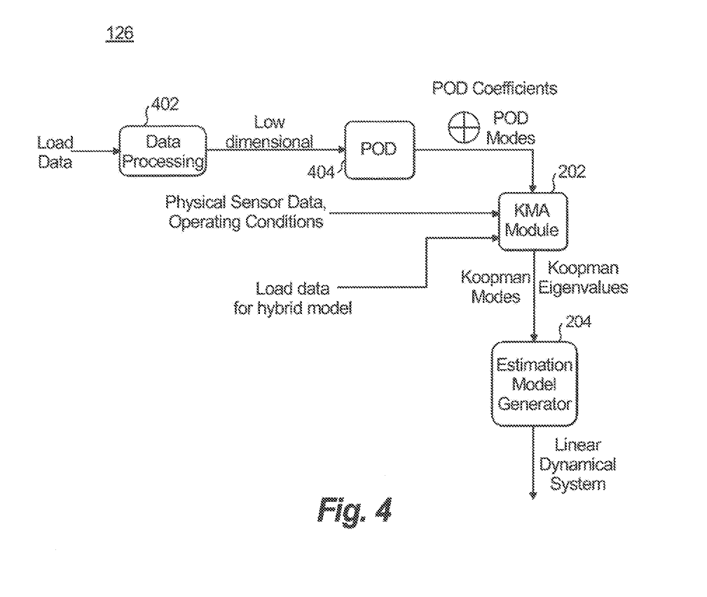

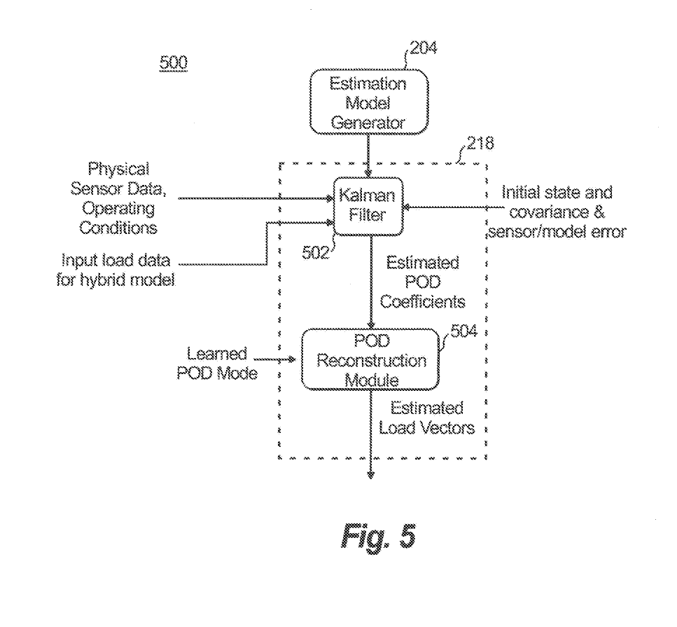

With reference to FIG. 4, a flow diagram of a portion of another embodiment of the KMA learning module 126 is shown in accordance with an embodiment of the disclosure referenced in FIG. 2 as the KMA Learning Module 126. As shown in FIG. 4, load data is processed by a data processing module 402. The data processing module 402 outputs the processed load data to a Proper Orthogonal Decomposition (POD) learning module 404, which applies a POD procedure (e.g., a standard POD procedure) in which load vectors are converted into lower dimensional POD coefficients. The POD module 404 also computes POD modes associated with POD coefficients which are needed in POD reconstruction module 504 as discussed below with reference to FIG. 5. Once this transformation is done, the POD coefficients and physical sensor data and operating condition data can be processed as a function of time by the KMA module 202. The KMA module 202 outputs Koopman eigenvalues and Koopman modes results to the estimation model generator 204 to generate the estimation model. In an embodiment, aircraft parametric state data, physical sensor data, and/or load data for a hybrid model can be provided to the KMA module 202. Accordingly, the modified KMA learning module 126 shown in FIG. 4 can be used with non-hybrid and hybrid load estimation models.

With reference to FIG. 5, a flow diagram is shown in accordance with an embodiment of the disclosure. The estimator 218 includes a Kalman filter 502, and a POD reconstruction module 504. The KMA module 202 outputs data to the Kalman filter 502 of the estimator 218. Physical sensor data, operating conditions, and input load data for a hybrid model are provided to the Kalman filter 502. Also provided to the Kalman filter 502 are initial state and covariance data and sensor/model error data. The Kalman filter 502 outputs estimated POD coefficients to the POD reconstruction module 504. The POD reconstruction module 504 further receives learned POD modes (computed by POD module 404, see FIG. 4) and outputs estimated load vectors. Thus, a potential advantage of some embodiments of the LBSHM system 100 is that KMA can be used to build dynamic correlation models to relate measured sensor data to unmeasured load data. Some embodiments of the LBSHM system 100 use a linear system based analysis in an abstract application of Koopman eigenvalues and Koopman modes that can capture nonlinearities and transient spatiotemporal correlations in the sensor data. In some embodiments, spectral information derived from the KMA can be transformed into a linear estimation model. In addition, in some embodiments, the linear estimation model can be used with linear system and/or control theoretic approaches to develop algorithms for load estimation, load prediction, fault detection and isolation, and sensor selection optimization. In some embodiments, the KMA can capture nonlinearities and transients in measured sensor data.

KMA provides a nonlinear analysis of data without linearity assumption. Modal decomposition in KMA captures the oscillatory behavior with growth/decay rates, which provides for the capture of transients in the data.

Since the estimation model used in the LBSHM system 100 captures dynamic correlations, the LBSHM system 100 can be used for predicting sensor data related to a dynamical system. An estimation model generated by the estimation model generator 204 that is used to estimate sensor data can be coupled with the estimator 218 (e.g., having Kalman filter 502). The estimator 218 output can be used for prediction, sensor data reconstruction, sensor fault detection and isolation, and fault detection and isolation. While shown and described in the exemplary context of load-based structural health monitoring for aircraft, those skilled in the art will readily appreciate that KMA and linear estimations in accordance with this disclosure can be used in other suitable applications, such as building equipment load estimation/prediction.

The methods and systems of the present disclosure, as described above and shown in the drawings, provide for processing sensor data from a dynamical system with superior properties including capturing spatiotemporal correlations in the sensor data. While the apparatus and methods of the subject disclosure have been shown and described with reference to preferred embodiments, those skilled in the art will readily appreciate that changes and/or modifications may be made thereto without departing from the spirit and scope of the subject disclosure.

1. A system to perform loads-based structural health monitoring (LBSHM) of a dynamical system, the system comprising a computer configured to:
receive sensor data output by a plurality of sensors sensing at least one of a dynamical parametrical state and a response of the dynamical system;
determine a Koopman mode and a Koopman eigenvalue, the Koopman mode representing a correlation between the sensor data output by the plurality of sensors, the Koopman eigenvalue representing a frequency component associated with the sensor data and growth or decay of energy associated with the sensor data; and
generate an estimation model to determine a linear estimation based on the Koopman mode and the Koopman eigenvalue that estimates a load response of the dynamical system based on growth or decay of energy associated with the sensor data.

2. The system according to claim 1, wherein the computer is further configured to receive sensor data output by a plurality of sensors sensing a load of the dynamical system.

3. The system according to claim 1, wherein a dynamic mode decomposition method is used to determine the Koopman mode and eigenvalue.

4. The system according to claim 1, wherein the dynamical system is a rotorcraft.

5. The system. according to claim 1, wherein the estimation model is used to estimate sensor data associated with a location remote from the plurality of sensors.

6. The system according to claim 1, wherein the estimation model is used to predict sensor data associated with a future time.

7. The system according to claim 1, wherein the estimation model is used to estimate sensor data that correspond to virtual sensor locations only.

8. The system according to claim 1, wherein the estimation model is used to estimate sensor data that correspond to a combination of physical sensor and virtual sensor locations.

9. The system according to claim 1, wherein the estimation model is used to determine accuracy of the estimation model.

10. The system according to claim 1, wherein the estimation model is used to detect that sensor data that is expected is not available, missing, or corrupt.

11. The system according to claim 1, wherein the estimation model is used to determine reconstructed sensor data for sensor data that is not available, missing or corrupt.

12. The system according to claim 1, wherein the estimation model is used to at least one of detect and isolate a fault in the dynamical system.

13. The system according to claim 1, wherein the estimation model is used to determine an optimal physical sensor network for use by the dynamical system.

14. A method to perform loads-based structural health monitoring (LBSHM) of a dynamical system, the method comprising:
receiving, by at least one computer, sensing data responsive to sensing at least one of a parametrical state and a response of the dynamical system;
determining, by the at least one computer, a Koopman mode and a Koopman eigenvalue, the Koopman mode representing a correlation between the sensor data output by a plurality of sensors, the Koopman eigenvalue representing a frequency component associated with the sensor data and growth or decay of energy associated with the sensor data; and
generating, by the at least one computer, an estimation model to determine a linear estimation based on the Koopman mode and the Koopman eigenvalue that estimates a load response of the dynamical system based on growth or decay of energy associated with the sensor data.

15. The method according to claim 14, further comprising receiving sensing data responsive to sensing a load of the dynamical system.

16. The method according to claim 14, wherein a dynamic mode decomposition method is used to determine the Koopman mode and eigenvalue.

17. The method according to claim 14, wherein the dynamical system is a rotorcraft.

18. The method according to claim 14, further comprising using the estimation model to estimate sensor data associated with a location remote from the plurality of sensors.

19. The method according to claim 14, further comprising using the estimation model to predict sensor data associated with a future time.

20. The method according to claim 14, further comprising using the estimation model to at least one of detect and isolate a fault in the dynamical system.

21. The method according to claim 14, further comprising determining an optimal physical sensor network based on estimation model for use by the dynamical system.

22. A method to capture spatiotemporal correlations in data sensed from a dynamical system, the method comprising:
correlating, by at [east one computer, spatial and temporal characteristics of sensor data based on sensing at least one of a dynamical system parametrical state and a dynamical system response using a Koopman mode;
representing, by the at least one computer, a frequency component associated with the sensor data and growth or decay of energy associated with the sensor data using a Koopman eigenvalue; and
generating, by the at least one computer, a linear estimation based on the Koopman mode and the Koopman eigenvalue to estimate a load response of the dynamical system based on growth or decay of energy associated with the sensor data.

23. The method according to claim 22, further comprising sensing a load of the dynamical system.

24. The method according to claim 22, wherein the dynamical system is a rotorcraft.

25. The method according to claim 22, further comprising determining an optimal physical sensor network based on estimation model for use by the dynamical system.

26-35. (canceled)
